(19) United States
(12) Patent Application Publication
(10) Pub. No.: US 2008/0050516 A1
(43) Pub. Date: Feb. 28, 2008

(54) MANUFACTURED SPORT AND RECREATIONAL SURFACE COMPOSITIONS AND METHODS FOR MAKING SAME

(76) Inventor: Michael W. DICKINSON, North East, MD (US)

Correspondence Address: MCGUIREWOODS, LLP, 1750 TYSONS BLVD, SUITE 1800, MCLEAN, VA, 22102, US

(21) Appl. No.: 11/620,470

(22) Filed: Jan. 5, 2007

Related U.S. Application Data
(60) Provisional application No. 60/823,471, filed on Aug. 24, 2006.

(51) Int. Cl. B05D 1/12

(52) U.S. Cl. 427/180

(57) ABSTRACT

A manufactured surface for use as a recreational and sports surface, such as equestrian tracks, that includes appropriate amounts of various components such as sand, rubber, plastic, cut length elastic fibers, polyester, and natural and/or manufactured fibers and a wax coating. The surface may be placed over a crushed aggregate layer which provides drainage to an area and may also contain a separator layer to prevent the passage of particulate material from the composition. Furthermore, a method of manufacturing the same is disclosed.

### CROSS-REFERENCE TO RELATED APPLICATIONS

This application claims priority to and the benefit of U.S. Provisional Application No. 60/823,471, filed Aug. 24, 2006, the disclosure of which is expressly incorporated herein by reference in its entirety.

### BACKGROUND

1. Field of the Invention

The invention relates to composite materials that can be used to form a manufactured surface which is an all-weather surface suitable for thoroughbred race courses and equestrian facilities, such as training tracks, horse paths, indoor and outdoor arenas and the like. Additionally, the manufactured surface may also be used for recreational surfaces such as jogging trails, paths, and running area for human, animals, automobiles, motorcycles and the like. The manufactured surface of the invention provides for a surface that is environmentally safe, non-toxic, and non-irritating.

2. Related Art

Typically, horses are raced on turf, sand or dirt tracks. The conditions of these surfaces can vary considerably depending upon the weather. Cantering, galloping, and jumping put considerable stress on a horse's forelegs, therefore it is important that the surface is not too hard. A hard surface greatly increases the risk of injuries, particularly when the horses are two or three years old. At this age, the horses are particularly susceptible to injury because their muscles and joints are not yet fully mature.

Numerous artificial surfaces have been developed. For instance, U.S. Pat. No. 5,326,192 to Freed, which is hereby incorporated in its entirety by reference, teaches a method of improving a turf surface by adding about 0.1 to 0.5 percent by weight of synthetic fibers into areas that contain turf or soil such that the synthetic fibers anchor the turf beneath the surface and mix with the turf above the surface. Similarly, two other soil reinforcement methods; U.S. Pat. Nos. 4,790,691 and 4,867,614, both to Freed, which are hereby incorporated in their entirety by reference, disclose the reinforcement of soil by mixing together soil and about 0.1 to 0.5 percent by weight of man-made fiber forming substances and/or fiberglass ('614) or thermoplastic polymers and/or fiberglass ('691).

U.S. Pat. No. 4,501,420 to Dury, which is hereby incorporated in its entirety by reference, discloses a method of making a sport surface by laying at least one flexible, water-permeable material containing sand on a water-permeable surface and placing a sheet or resilient material on top of it.

U.S. Pat. No. 4,819,933 to Armond, which is hereby incorporated in its entirety by reference, discloses a sport surface comprising a layer of sand mixed with less than 1.0% by weight of long synthetic fibers, which is laid on top of a prepared drainage base. The Armond surface requires copious amounts of water on a frequent basis in order to prevent the surface from drying out and becoming hard and non-resilient.

U.S. Pat. No. 5,014,462 to Malmgren et al., which is hereby incorporated in its entirety by reference, discloses a method of preparing soil to improve its porosity and reduce it from being compacted. The method comprises loosening the top layer of soil and mixing at least about 10% by volume of solid rubber particles and grass seed into the soil layer.

U.S. Pat. No. 5,041,320 to Meredith et al., which is hereby incorporated in its entirety by reference, teaches a sport surface which comprises a pile fabric and a layer of rubber coated mineral grains (e.g., sand) in which the pile is partly submerged.

U.S. Pat. No. 4,337,283 to Haas, Jr., which is hereby incorporated in its entirety by reference, discloses a synthetic turf playing surface which comprises a subsurface layer (e.g., concrete, clay, dirt, etc.), a moisture barrier layer, a pile fabric layer and a compacted top-dressing layer.

However, there are several disadvantages associated with these surfaces. One disadvantage, for example, is that many of the artificial tracks are prone to water retention, which can result in pooling and instability. Also, in cold weather, any water retained on the track may freeze, and water retention may also cause inconsistencies in ground compaction which may result in disruptions in a horse's natural stride and may affect performance or even lead to injury. Another disadvantage of some tracks is that they are short lived and must be replaced often. Yet another disadvantage is that some tracks become compacted with use.

Until applicant developed the new artificial surface that is the subject of his prior U.S. Pat. No. 5,961,389, no artificial surface has been commercially acceptable, especially in the equestrian field. The surface compositions disclosed in this patent have the advantages of being resistant to compaction, resistant to water retention, have good shock absorption, can be easily maintained, have good service life, and utilize environmentally friendly materials, such as recycled tire and scrap plastic.

The applicant has now made improvements to the artificial surface of his original patent that yields a surface that is stronger, has greater stability, has a greater tensile strength, longer service life, and can be inexpensively maintained.

### SUMMARY OF THE INVENTION

The invention provides a sport and recreational surface that retains all of the advantages of the applicant's prior U.S. Pat. No. 5,961,389 but has improved stability and tensile strength and a longer service life compared to the compositions in his prior patent and those currently being marketed by others.

The invention may be implemented in a number of ways, which are described in the appended claims.

Additional features, advantages, and embodiments of the invention may be set forth or apparent from consideration of the following detailed description, and claims. Moreover, it is to be understood that both the foregoing summary of the invention and the following detailed description are exemplary and intended to provide further explanation without limiting the scope of the invention as claimed.

### DETAILED DESCRIPTION OF THE INVENTION

It is understood that the invention is not limited to the particular methodology, protocols, and reagents, etc., described herein, as these may vary as the skilled artisan will recognize. It is also to be understood that the terminology used herein is used for the purpose of describing particular embodiments only, and is not intended to limit the scope of the invention. It also is be noted that as used herein and in the appended claims, the singular forms “a,” “an,” and “the” include the plural reference unless the context clearly dictates otherwise. Thus, for example, a reference to “a fiber” is a reference to one or more fibers and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

Moreover, provided immediately below is a “Definition” section, where certain terms related to the invention are defined specifically for clarity, but all of the definitions are consistent with how a skilled artisan would understand these terms. Particular methods, devices, and materials are described, although any methods and materials similar or equivalent to those described herein can be used in the practice or testing of the invention. All references referred to herein are incorporated by reference herein in their entirety.

### DEFINITIONS

PE is polyethylene

PP is polypropylene

PS is polystyrene

PETE is polyethylene terephthlate

PA is polyamide

PVC is polyvinyl chloride

PC is polycarbonate

ABS is acrylonitrile butadiene styrene

PVDC is polyvinylidene chloride

PTFE is polytetrafluorethylene

PFA is perfluroalkoxy polymer resin

FEP is fluorinated ethylene-propylene

ETFE is ethylene tetrafluorethylene

ECTFE is ethylene chlorofluoroethylene

PVDF is polyvinylidene fluoride

PCTFE is polychorotrifluorethylene

TFE is trifluoroethanol

FPM is a fluorine rubber compound

CTFE is chlorotrifluorothylene

FFKM is perfluoroelastomer

FKM is fluorinated elastomers

PET is polyethylene terephthalate

SBR is styrene butadiene rubber

PLA is polylactic acid

PBI is polybenimidazole

EPM is ethylene propylene rubber

The term “sand” refers to any granular material formed by the disintegration of rocks to form particles smaller than gravel but coarser than silt.

The term “fiber(s)” refer to any ribbons, strips or fragments of material used to, inter alia, add mechanical strength and/or color(s) to the manufactured surface.

The term “particle(s)” refers to any pieces, parts or portions of material used to, inter alia, add mechanical strength and aid is drainage of the manufactured surface.

The term “plastic(s)” refers to synthetic or semi-synthetic polymerization products and are polymers of long chains of atoms bonded to one another. The plastic products may be composed of organic condensation or addition polymers and may contain other substances to improve performance or economics. Plastic may be used in the manufactured surface to add mechanical strength, aid in drainage, and may be used to add color to the manufactured surface.

The term “cut length elastic fiber(s)” or “CLEF(s)” refers to any material that has the ability to recover its original size and shape immediately after removal of stress that causes deformation of the material. The CLEF may be used in the manufactured surface to increase the tensile strength of the surface and also to add color to the manufactured surface.

The terms “elastomer” or elastomeric” refer to various elastic materials that may resemble rubber and resumes its original shape when a deforming force is removed.

The invention provides an environmentally safe, non-toxic, and non-irritating manufactured surface that may be used as a sport and recreational surface. More specifically, the manufactured surface may be used for horse race courses, jumping arenas, training tracks, indoor and outdoor arenas, and other equestrian facilities. The invention creates an ideal equestrian footing that reduces shock and provides cushioning to the feet of running and jumping horses, while still providing sufficient resistance to their rear legs so that they may increase and maintain their speed. The surface is stable, non-slip, dust-resistant, water-resistant and easily drained. Unlike natural track surfaces and some artificial surfaces, the compositions of the invention require minimal irrigation, thereby reducing the cost of water, machinery and manpower resources. Furthermore, the surface requires relatively little maintenance such as grading and harrowing. Moreover, the surface disclosed herein will be available for use more often than conventional surfaces during the rainy season. Also, the excellent drainage properties reduce the likelihood of injuries to athletes or animals that run on the surface. The manufactured surface may also be used for recreational purposes such as jogging trails, paths, and running areas for human, animals, automobiles, motorcycles and the like.

While the surfaces disclosed in applicant's prior patent have proven to be resistant to compaction and water retention, have good shock absorption, easily maintained, and have good service life, applicant has made improvements to the surface composition of his prior patent. What has been surprisingly found is that the use of polyester fibers and/or CLEFs, such as spandex or lastol, in the track composition yields a manufactured surface that is more stable, has an increased tensile strength, and longer service life.

According to an embodiment of the invention, the components employed in the manufactured surface compositions may be a combination of any natural and/or synthetic materials, such as natural or manufactured fiber products, plastic, sand, and a resin, such as wax. The resin serves as a coating to seal and protect the additional manufactured components from environmental influences and to impart a degree of slip so that the desired cushioning is achieved when initially cooled after coating. Additionally, the components may be colored to add any desired color(s) to the manufactured surface.

The appropriate components of the inventions as described herein are combined and mixed together in a mixer as is known in the art. For example, any combination of sand, natural and/or manufactured fibers, rubber, and plastic in the appropriate amounts may be added and mixed together in a mixer. All of the components are essentially dry solids. The intimate dry mixture is then mixed with a suitable hydrocarbon wax such as paraffin wax or a mixture of waxes. These waxes are readily available from a variety of commercial sources. They usually comprise high molecular weight materials and are preferably mineral waxes derived from petroleum by-products, for example, dewaxing light lubricating oil stocks (e.g., paraffin waxes). The wax is first heated to liquefy it and the melted wax is coated in a substantially uniform layer over each ingredient. The coating is typically achieved by spraying the melted wax over the essentially dry mixture as it is being stirred or tumbled in a suitable mixer, for example, in the same mixer used initially to intimately mix the essentially dry surface components.

The resin may be a wax and can be of any suitable nature provided that it has a sufficiently high enough melting point. The wax is chosen to have a relatively high melting point such that it does not melt or soften to any substantial extent during use, keeping in mind that under summer conditions the sport or recreational surface may reach temperatures well in excess of 100° F. Accordingly, the melting point of the wax should be in greater than about 120° F. and under some circumstances greater than about 170° F. Generally, most waxes do not have a sharply defined melting point, but rather, melt over a range of about 10° F. to about 30° F. In any event, the melting point must be sufficiently high such that the sport or recreational surface will not become sticky and the particulate material will not unduly clump and/or stick together when cooled. The wax coating serves to seal and protect the particulate materials from environmental influences and to impart a degree of slip so that the desired cushioning is achieved when initially cooled after coating. The coated particulate material of this invention may solidify into lumps or clumps, but these solids are easily broken up by hand or with a powered mixer. Once broken up, the finished mixture will retain its particulate nature.

The compositions of the invention may be advantageously laid down on the ground over a layer of material that will provide good drainage. While the manufactured surface may be laid over practically any type of surface, for example, cement, soil, dirt, clay, turf, and other suitable materials, it is may be preferable to lay it a surface that will maximize the drainage benefits of the invention. In particular, it may be laid over cement. In use, rain or irrigation water will quickly penetrate and drain through the composition. This is a necessary characteristic, and to be certain that the water will completely drain through the mixture, an aggregate layer or other underlayment of, for example, crushed or broken gravel, stone, or other aggregate (e.g., quarry, granite or limestone fines or dust), or a mixture thereof, is desired. To provide enhanced drainage functions, the underlayer should have a depth in the range of about 3 inches to about 4 inches and be full of about 1 inch to about 4 inches of aggregate, such as crushed washed stone which is about ¼ inch to about 2 inches in diameter. Specifically, the underlayer will be at least about 6 inches deep and contain at least about 4 inches of crushed washed stone. Advantageously, a pipe will be laid down with the crushed stone to facilitate rapid egress of any water. The size and uniformity of the drainage underlayer are not critical so long as drainage is accomplished and the particulate mixture of the invention does not significantly penetrate the drainage layer.

The drainage underlayer may occupy the same linear dimensions in width and length as the manufactured surface. However, the underlayer may be longer, shorter, wider, or thinner than the manufactured surface so long as the function of drainage is not significantly compromised. The composition may be spread over the drainage underlayer to a suitable depth of at least about 4 inches, and specifically at least about 5 inches to about 6 inches. The thickness may be increased beyond these limits, but considerations of increased cost versus diminution of enhanced benefits impose practical limits on thickness. The compositions of the invention can be used for long periods of time, for example, for at least up to about 5 years, but eventually they will break down and require replacement or refurbishing. Usually, the wax, and not the particulate materials, degrades and the original particles can simply be recoated with wax in a suitable mixing device. Thus, as one skilled in art readily appreciates the percent by weight of the components, particularly the wax, used in the surface compositions of the invention means the amount of percent by weight at the time the component was initially and the surface is first installed.

In particular, a water-permeable separator layer, such as a suitable textile, net mesh, other porous membrane layer, or a mixture thereof will be interposed between the sport surface and the drainage layer. The separator layer may be natural or synthetic. In a specific embodiment of the invention, a metal screen or a Geotextile membrane separates the particulate materials of the invention, especially the sand, from the drainage materials (e.g., crushed stone). Covering the crushed stone with a porous membrane may prevent the intermixing of the surface layer with the drainage area. Without a separator layer, the sand content of the surface layer may ultimately leach into the crushed stone, thereby reducing drainage and modifying the composition of the surface layer, or at least that portion which is closest to the crushed stone. Suitable separator materials are chosen based on the particle size of the surface composition, its durability and its resistance to deterioration. Any material is satisfactory so long as it allows water to pass through it, while blocking the passage of any particulate matter.

The compositions of the invention include the following ingredients in the stated ranges by weight, based on the total weight of each composition, although volume measurements will also work. In general, the manufactured surface may contain sand in the range of about 50% to about 92% by total weight of the composition, wax in the range of about 3% to about 15% by total weight of the composition, polyester fibers in the range of about 0.5% to about 10% by total weight of the composition, and CLEFs in the range of about 0.5% to about 10% by total weight of the composition. In a further embodiment, the surface composition may also include manufactured or natural fibers in the range of about 0.5% to about 10% by total weight of the composition, rubber particles and/or fibers in the range of about 1% to about 15% by total weight of the composition, and plastic particles in the range of about 0.5% to about 10% by total weight of the composition.

In one specific embodiment of the invention, the manufactured surface includes about 85% sand by total weight of the composition, about 7% wax by total weight of the composition, about 1% manufactured and/or natural fibers by total weight of the composition, about 1% CLEF by total weight of the composition, about 1.5% polyester fibers by total weight of the composition, about 1% plastic particles by weight of the total composition, and about 5% rubber particles and/or fibers by total weight of the total composition.

The sand employed in the manufactured surface composition may be of any common type or grade, such as silica sand, with the choice determined by availability and cost. In a specific embodiment, the sand may be dried or pre-heated to dry it before the mixing step because too much moisture in the sand can reduce the capability of the wax to coat the sand. The average particle size (in diameter) of the sand may vary widely, but it is preferred that the sand will pass substantially through a number 7 U.S. mesh screen while being retained substantially on a number 200 U.S. mesh screen.

The wax for use in the composition of the invention may be natural or artificial. The wax may be an ester of ethylene glycol (ethan-1,2-diol) and two fatty acids. Additionally, it may also be a combination of fatty alcohols with fatty acids. The wax for use with the invention may include, without limitation, animal and insect waxes such as beeswax, Chinese wax, shellac wax, spermaceti, lanolin; vegetable waxes such as bayberry wax, candelilla wax, camauba wax, castor wax, esparto wax, Japan wax, jojba oil, ouricury wax, rice bran wax; mineral waxes such as ceresin waxes, montan wax, ozocerite, peat wax, paraffin wax, microcrystalline wax; and synthetic waxes such as polyethylene waxes, Fischer-Tropsch waxes, chemically modified waxes (i.e., esterified of saponified), substituted amide waxes, and polymerized α-olefins.

The wax may have a relatively high melting point, so that it does not melt or soften to any substantial extent during use. Also, since under summer conditions the track surface of the invention may reach temperatures in excess of about 100° F., the melting point of the wax should be greater than about 120° F. Furthermore, the melting point of the wax must be sufficiently high such that the manufactured surface of the invention does not become sticky and such that the other components of the manufactured surface do not unduly clump and/or stick together when cooled.

In an additional embodiment, the resin may include any suitable thermosetting resins, photosetting resins, phenolformaldehyde, phenol resins, epoxy resins, polysiloxane resins, polyurethanes, polysiloxanes, poly(vinyl chloride), polyisoprene-cis, polyisobutylene, polybutadience, styrene butadience copolymers (SBR), nitrile rubber (NBR, acrylonitrile-butadiene random copolymers), butyl rubber (isoprene-isobutylene copolymers), acrylonitrile-butadiene-styrene copolymers (ABS), polychlrorprene, and poly(ethylene-stat-propylene). However, as one skilled in the art would recognize, there are numerous resins that are suitable for use as a coating.

CLEFs may be used in the manufactured surface composition. The addition of CLEFs unexpectly improves the overall tensile strength of the manufactured surface. Representative examples of CLEFs include spandex and lastol. Spandex or elastane is a manufactured fiber where the fiber-forming substance is a long chain synthetic polymer comprised of at least about 85 percent of segmented polyurethane and is known for its exceptional elasticity. Spandex is stronger and more durable than rubber. Furthermore, spandex has the following physical properties, (i) may be stretched over about 500% without breaking, (ii) able to be stretched repetitively and still recover original length, (iii) lightweight, abrasion resistant, (iv) stronger and more durable than rubber, (v) soft, smooth, and supple, and (vi) resistant to body oils, perspiration, lotions, and detergents. Spandex is commercially known by trademarks including without limitation, Lycra®, Elaspan®, Dorlastan®, and Linel®. Lastol (Dow Chemical Corporation) is a manufactured crosslinked elastic fiber in which the fiber forming substance is a synthetic polymer, with low but significant crysallinity, composed of at least about 90% by weight of ethylene and at least one other olefin unit and where the fiber exhibits elasticity and heat resistance properties not present in transitional olefin fibers. Lastol has unique elastic properties and thermal resistance properties.

The plastic particles used in the invention may be derived from a variety of synthetic or semi-synthetic polymerization products. For example, the plastic particles may include include low carbon chain polyolefins such as high and/or low density polyethylene, polypropylene and/or copolymers thereof, cellulose-based plastics, such as celluloid and rayon, polystyrene, PVC, nylon, synthetic rubber, polyurethane, PET, PTFE, polyamide, polyester, polycarbonate, acrylonitrile butadiene styrene, polyvinylidene chloride, polytetrafluoroethylene, plastarch material, bakelite, polylactic acid, Formica®, and acrylic. A skilled artisan would appreciate that the plastic particles used suitable for use in the invention, may be obtained from a variety of sources, such as recycled scrap plastics.

In one specific embodiment, the plastics may be ground, chopped or otherwise cut into thin coarse particles and have a length in the range of about ½ inches to about 1 inch, and in particular a length in the range of about ⅝ inches to about ⅞ inches, and specifically about ¾ inch. Additionally, the plastic particles may have a thickness in the range of about 1/32 inches to about 1/16 inches. The narrowness of these particles may be critical and unexpectedly contributes to superior cushion and drainage characteristics to the sport surface. These particles contribute improved resilience and drainage and can be further used to control the color of the manufactured surface.

The natural and/or manufactured fibers that may be suitable in the practice of the invention comprise a variety of chopped, shredded and/or cut fibers, described in detail below. These fibers may be commercially available from a variety of sources. The fibers may be straight or curly and have a length in the range of about ¼ inches to about 2 inches, and more particularly have a length in the range of about ½ inches to about 1½ inches. Additionally, the fibers may have a thickness in the range of about 1/24 inches to about ¼ inches, and more particularly, have a thickness in the range of about 1/16 inches to about ⅛ inches. Examples of various manufactured fibers suitable for the manufactured surface of the invention may include without limitation rayon, acetate, nylon, modacrylic, olefin, acrylic, polyester, PLA, vinyon, saran, spandex, vinalon, aramid, nomex, Kevlar, modal, PBI, sulfar, lyocell, zylon, dyneema/spectra, rubber, and acrylontrile rubber.

Acrylic is a manufactured fiber where the fiber-forming substance is any long chain synthetic polymer composed of less than about 85% but at least about 35% by weight of acrylonitrile units. Polyester is a manufactured fiber where the fiber-forming substance is any long chain synthetic polymer composed of at least about 85% by weight of an ester of a substituted aromatic carboxylic acid, including without limitation to substitute terephthalate units and para substituted hydroxyl-benzoate units. The fiber may be formed by the interaction of about 2 or more chemically distinct polymers (of which non exceeds about 85% by weight), and contains ester groups as the dominant functional unit (at least about 85% by weight of the total polymer content of the fiber), and which, if stretched at least about 100%, durably and rapidly substantially reverts to its unstretched length when the tension is removed. Alternatively, the term elasterall-p may be used as a generic description of the fiber.

In a specific embodiment, the manufactured surface includes polyester fibers in an amount in the range of about 1% to about 10% by weight of the total composition. In particular, the polyester fibers may have a length in the range of about ½ inch to about 6 inches, and specifically may be cut to a length of about 1 inch. Addition of polyester fibers to the manufactured surface composition of this invention unexpectedly improves the overall stability of the manufactured surface.

Rayon is a manufactured fiber composed of regenerated cellulose, as well as manufactured fibers composed of regenerated cellulose where substituents have replaced not more than about 15% of the hydrogens of the hydroxyl groups. Additionally, the fiber may be composed of cellulose precipitated from an organic solution in which no substitution of the hydroxyl groups takes place and no chemical intermediated are formed.

Acetate is a manufactured fiber in which the fiber-forming substance is cellulose acetate. The term triacetate may be used as a generic description of the fiber when not less than about 92% of the hydroxyl groups are acetylated. Saran is a manufactured fiber where the fiber-forming substance is any long chain synthetic polymer composed of at least about 80% by weight of vinylidene chloride units. Azlon is a manufactured fiber is a manufactured fiber where the fiber-forming substance is composed of any regenerated naturally occurring proteins. Nytril is a manufactured fiber containing at least about 85% of a long chain polymer of vinylidene dinitrile where the vinylidene dinitrile content is no less that every other unit in the polymer chain. Nylon is a manufactured fiber where the fiber-forming substance is a long-chain synthetic polyamide in which less that about 85% of the amide linkages are attached directly to two aromatic rings. Nylon is a manufactured fiber in which the fiber-forming substance is a long-chain synthetic polyamide in which less than about 85 percent of the amide linkages are attached directly to two aromatic rings.

Vinal is a manufactured fiber where the fiber-forming substance is any long chain synthetic polymer composed of at least about 50 percent by weight of vinyl alcohol units and such that the total of the vinyl alcohol units and any one or more of the various acetal units is at least about 85 percent by weight of the fiber.

Olefin is a manufactured fiber in which the fiber-forming substance is any long chain synthetic polymer composed of at least about 85 percent by weight of ethylene, propylene, or other olefin units, except amorphous (noncrystalline) polyolefins. The term lastol may be used when the fiber-forming substance is a cross-linked synthetic polymer, with low but significant crystallinity, composed of at least about 95 percent by weight of ethylene and at least one other olefin unit, and the fiber is substantially elastic and heat resistant.

Vinyon is a manufactured fiber where the fiber-forming substance is any long chain synthetic polymer composed of at least about 85 percent by weight of vinyl chloride units. Metallic fiber (Lurex Company Limited) is a manufactured fiber composed of metal, plastic-coated metal, metal-coated plastic, or a core completely covered by metal.

Anidex is a manufactured fiber where the fiber-forming substance is any long chain synthetic polymer composed of at least about 50 percent by weight of one or more esters of a monohydric alcohol and acrylic acid. Novoloid is a manufactured fiber containing at least about 85 percent by weight of a cross-linked novolac. Aramid (Dupont Company, Delaware) is a manufactured fiber in which the fiber-forming substance is a long-chain synthetic polyamide such that at least about 85 percent of the amide linkages are attached directly to two aromatic rings. Examples of materials produced from aramid fibers include without limitation, Kevlar and Nomax.

Sulfar (Toray Industries, Inc. Japan) is a manufactured fiber in which the fiber-forming substance is a long chain synthetic polysulfide in which at least about 85% of the sulfide linkages are attached directly to about two (2) aromatic rings. PBI (Celanese Corporation) is a manufactured fiber where the fiber-forming substance is a long chain aromatic polymer having reoccurring imidazole groups as an integral part of the polymer chain. Elastoester is a manufactured fiber where the fiber-forming substance is a long-chain synthetic polymer composed of at least about 50% by weight of aliphatic polyether and at least about 35% by weight of polyester. Melamine is a manufactured fiber where the fiber-forming substance is a synthetic polymer composed of at least about 50% by weight of a cross-linked melamine polymer.

Fluoropolymer is a manufactured fiber containing at least about 95% of a long-chain polymer synthesized from aliphatic fluorocarbon monomers. PLA is a manufactured fiber in which the fiber-forming substance is composed of at least about 85% by weight of lactic acid ester units derived from naturally occurring sugars. Examples of fluorpolymers may include without limitation, PTFE (Teflon®), PFA (also known as Teflon®), FEP (also known as Teflon®), ETFE (Tefzel®), Fluon®, ECTFE (Halar®), PVDF (Kynar®), PCTFE (Kel-F®), TFE, FPM, CTFE, FFKM (Kalrez®, Tecnoflon FFKM®), and FKM (Viton®, Tecnoflon®).

The natural fibers suitable for use in the invention may include vegetable fibers, animal fibers, and/or mineral fibers or any fibers having similar properties. Vegetable fibers may generally comprise cellulose and may include cotton, linen, jute, flax, ramie, sisal, agave, bast, kapok, kenaf, ramie, rattan, soybean, vine, bamboo, grass, and hemp. Animal fibers may include wool, goat hair, horse hair, and silk fiber. Mineral fibers are naturally occurring fibers or slightly modified fibers procured from minerals. Mineral fibers include without limitation asbestos, serpentine, amphiboles, amosite, crocidolite, tremolite, actinolite, anthophyllite, ceramic, glass fibers (i.e., glass wool and quartz), aluminum oxide, silicon carbide, boron carbide and aluminum fibers.

As in applicant's prior U.S. Pat. No. 5,961,389, rubber is another component that may be used in the manufactured surface of this invention. The term “rubber” is used in this invention in the same manner as it is used in U.S. Pat. No. 5,961,389, which is how a person of ordinary skill in the art would interpret the term “rubber.” Specifically, for example, as defined by the Federal Trade Commission (16 CFR §303.7), rubber is a manufactured fiber in which the fiber-forming substance is comprised of natural or synthetic rubber, including, without limitation, the following categories:
(i) A manufactured fiber in which the fiber-forming substance is a hydrocarbon such as natural rubber, polyisoprene, polybutadiene, copolymers of dienes and hydrocarbons, or amorphous (noncrystalline) polyolefins;
(ii) A manufactured fiber in which the fiber-forming substance is a copolymer of acrylonitrile and a diene (such as butadiene) composed of not more than about 50 percent but at least about 10 percent by weight of acrylonitrile units; and
(iii) A manufactured fiber in which the fiber-forming substance is a polychloroprene or a copolymer of chloroprene in which at least about 35 percent by weight of the fiber-forming substance is composed of chloroprene units.

The skilled artisan would readily appreciate that a variety of types of rubber and sources exist for obtaining rubber suitable for use in making the manufactured surface of the invention. A skilled artisan would appreciate that exemplary types of rubber may include without limitation, natural rubber, synthetic “natural” rubber, SBR, neoprene, nitrile, butyl, hypalon, EP rubber, urethane, epichlorohydrin, chlorinated polyethylene, polyvinyl chloride, polysulfide, silicon, acrylic, fluoroelastomers, polyacrylic rubber, EPM, tire fibers, and tire cord. Additionally, the rubber may be vulcanized rubber.

The skilled artisan would also appreciate that the rubber and other elastomeric materials may be readily obtained from recycling any variety of extruded, molded, vulcanized, or gasket/die cut rubber products, such as grommets, bumpers, stoppers, rubber tips, suction cups, gaskets, corrugated rubber mats, cables, crisscross mats, rubber tiles, and recycled tires.

The tire fibers and/or cord used in my prior patent and this invention typically comprise non-metallic reinforcing fibers and/or cord which are readily obtained from the recycling of truck or automobile tires. The fibers and/or cord, which may be made from synthetic or natural materials, are cut to suitable lengths of between about ¼ to 2½ inches, preferably ½ to 1½ inches, and may have small pieces of tire rubber (vulcanized rubber), other elastomeric materials and/or fabric still attached. The tire fibers and/or cord are light-weight, long lasting and soft, which improve the resiliency and the drainage characteristics of the surface. Furthermore, like with the polyolefin particles, using recycled or scrap tire materials promotes the environment.

Thus, from the preceding paragraph, a skilled artisan would appreciate that the terms “tire fiber” and/or “tire cord” may include pieces, strips, ribbons, or fragments of fabric and/or yarn, such as rayon, nylon, or polyester, which may have particles of rubber or other elastomeric materials attached, such as vulcanized rubber, SBR, tire rubber, and/or cable rubber. Moreover, one skilled in the art would appreciate that the terms “tire fibers” and/or “tire cords” refer to any synthetic or natural material such as, rubber and/or other elastomeric materials that are substantially free of any fabric as long as they are light-weight, long lasting and soft, which improve the resiliency and the drainage characteristics of the surface. Additionally, a skilled artisan would further appreciate that “tire cords” and/or “tire fibers” may be readily obtained from a variety of sources besides recycled tires, such as recycled ground rubber, virgin ground rubber (such as industrial rubber composed of SBR), recycled corrugated rubber mats, cables, and the like.

Without further elaboration, it is believed that one skilled in the art, using the preceding description, can utilize the invention to the fullest extent. The following examples are illustrative only, and not limiting of the disclosure in any way whatsoever.

### EXAMPLES

### Specific Example 1

The manufactured surface of this example was prepared from the following components as shown in Table 1 below:

TABLE 1

| Ingredients | Percent by Weight |
|---|---|
| Sand | 81.0 |
| Wax | 7.0 |
| Polyester fibers | 1.5 |
| Spandex fibers | 1.0 |
| PE | 4.0 |
| Rubber | 5.0 |

The sand employed in the example is No. 2 mason sand of medium consistency. The screen size analysis (by weight) is as follows (U.S. Mesh Screen): 100% through No. 8, 99.7% through No. 10, 97.6% through No. 30, 55.9% through No. 50, 9.2% through No. 100 and 10% through No. 200. The sand is pre-heated to drive off essentially all residual moisture until it appears dry and free flowing.

The polyester fibers used in this example had a length in the range of about ½ inch to about 1 inch and had a thickness in the range of about 1/16 inch to about ⅛ inches. The PE was ground to a particle of about ¾ inch long and about 1/24 inch thick. The rubber had a length in the range of about ¾ inch to about 1½ inches and had a width in the range of about 1/16 inch to about ⅛ inch. The spandex fibers used in this example had a length in the range of about ½ inch to about 1¼ inches and had a width in the range of about ½ inch to about 2 inches.

The sand, polyester, PE, spandex and rubber were thoroughly mixed together to form an intimate and essentially uniform mixture of essentially dry ingredients.

The petroleum hydrocarbon wax used in this example was heated and melted to greater than about 200° F. The melted (liquefied) wax was then intimately mixed with the remaining ingredients to coat them. The wax is characterized as a paraffin wax derived from petroleum by-products. It is dark brown to black in color, has a specific gravity of about 0.86, essentially no volatiles, a melting point in the range of about 130° F. to about 155° F. and was insoluble in water. Mixing was continued until essentially all of the particulate ingredients were covered with a thin wax coating.

The mixture was then cooled while mixing, and the wax was allowed to solidify. When cooled, some of the particulate materials clumped together, but they were easily broken up into smaller particulates either by hand or mechanically. The resulting mixture is then deposited over a bed of crushed stone or other suitable material which is about 6 inches in thickness (for drainage purposes). The mixture is applied to form a substantially uniform layer having a thickness in the range of about 5 inches to about 6 inches. Thus, the whole sport surface (top layer over crushed stone layer) is in the range of about 10 inches to about 13 inches thick. Before depositing the mixture of the invention over the crushed stone, a textile separator (e.g., Geotextile) is advantageously placed over the stone to keep the sand and other particulate material from filtering down into the stone area.

The resulting surface is elegantly suited, for example, as a stable, weather resistant artificial horse racing or equestrian track providing easy drainage, low dust, ease of maintenance and excellent cushioning. In fact, the combination of the stability, tensile strength and resilience of the track, and its drainage is superior to any other similar type of track on the market. The surface can also be used for exercise yards, show rings, and other locations where the characteristics of the invention are desired.

### Specific Example 2

The manufactured surface of this example is prepared from the following ingredients as shown in Table 2 below and the track is prepared by following the methodology as described in Specific Example 1, above:

TABLE 2

| Ingredients | Percent by Weight |
|---|---|
| Sand | 85.0 |
| Wax | 7.0 |
| Nylon fibers | 1.0 |
| Spandex fibers | 1.0 |
| PP | 1.0 |
| Rubber | 5.0 |

### Specific Example 3

The manufactured surface of this example is prepared from the following components as shown in Table 3 below and the track is prepared by following the methodology as described in Specific Example 1, above:

TABLE 3

| Ingredients | Percent by Weight |
|---|---|
| Sand | 88.0 |
| Wax | 5.0 |
| Polyester | 1.0 |
| Spandex fibers | 1.0 |
| Rubber | 5.0 |

The examples given above are merely illustrative and are not meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the relevant fields are intended to be within the scope of the appended claims.

The disclosures of all references and publications cited above are expressly incorporated by reference in their entireties to the same extent as if each were incorporated by reference individually.

What I claim is:

1. A particulate composition for use as a sport or recreational surface comprising:
sand in the range of about 50% to about 92% by weight;
resin in the range of about 3% to about 15% by weight;
cut length elastic fibers (CLEFs) in the range of about 0.5% to about 10% by weight;
polyester fibers in the range of about 0.5% to about 10% by weight;
rubber in the range of about 1% to about 15% by weight;
plastic in the range of about 0.5% to about 10% by weight; and
wherein each component is based on the total weight of the composition.

2. The particulate composition of claim 1, wherein said sand is about 85% by weight.

3. The particulate composition of claim 1, wherein said resin is about 7% by weight of wax.

4. The particulate composition of claim 1, wherein said CLEFs is about 1% by weight.

5. The particulate composition of claim 1, wherein said CLEFs are selected from the group consisting of spandex, lastol, and a combination thereof.

6. The particulate composition of claim 1, wherein said composition further comprises synthetic fibers in the range of about 0.5% to about 10% by weight of total composition and are at least one fiber selected from the group consisting of rayon, acetate, nylon, modacrylic, olefin, acrylic, PLA, vinyon, saran, spandex, vinalon, aramid, nomex, Kevlar, modal, sulfar, lyocell, zylon, dyneema/spectra, rubber, acrylontrile rubber, and any combination thereof.

7. The particulate composition of claim 1, wherein said rubber comprises a mixture of material from recycled tires and recycled ground industrial rubber.

8. The particulate composition of claim 1, wherein said rubber has a length in the range of about ¾ inch to about 1½ inches and a width in the range of about 1/16 inch to about ⅛ inch.

9. The particulate composition of claim 1, wherein said rubber comprises at least one material selected from the group consisting of a natural rubber, a synthetic “natural” rubber, a SBR, a neoprene rubber, a nitrile rubber, a butyl rubber, a hypalon rubber, an EP rubber, an urethane rubber, an epichlorohydrin rubber, a chlorinated polyethylene rubber, a polyvinyl chloride rubber, a polysulfide rubber, a silicon rubber, an acrylic rubber, a fluoroelastomer, a polyacrylic rubber, an EPM rubber, a tire fiber, a tire cord, and any combination thereof.

10. The particulate composition of claim 1, wherein said plastic has a length of about ¾ inch long and a thickness of about 1/24 inch.

11. The particulate composition of claim 10, wherein the plastic is selected from the group consisting of a low carbon chain polyolefin, a high density polyethylene, a low density polyethylene, a polypropylene, a cellulose-based plastic, a polystyrene, a polyvinyl chloride (PVC), a nylon, a polyurethane, a polyethylene terephthlate (PET), a polytetrafluoroethylene (PTFE), a polyamide, a polyester, a polycarbonate, an acrylonitrile butadiene styrene, a polyvinylidene chloride, a polytetrafluoroethylene, a plastarch material, a bakelite, a polylactic acid, an acrylic, and any combination thereof.

12. The particulate composition of claim 1, wherein said composition is spread over an underlayer capable of drawing water away from said surface composition.

13. The particulate composition of claim 12, wherein a water-permeable separator layer is placed between said surface composition and said underlayer.

14. The particulate composition of claim 12, wherein said underlayer comprises an aggregate layer.

15. The particulate composition of claim 14, wherein said aggregate layer is one or more compounds selected from the group consisting of crushed stone, broken stone, gravel, stone, quarry, granite, limestone, and dust.

16. A method of rehabilitating or training an injured horse, comprising the step of exercising the horse on the surface of claim 1.

17. A method of making a sport or recreational surface, said method comprising the steps of:
admixing about 50% to about 92% by weight of sand, about 0.5% to about 10% by weight of cut length elastic fibers (CLEFs), about 0.5% to about 10% by weight of polyester fibers, and at least one of about 0.5% to about 10% by weight of natural and/or synthetic fibers, about 1% to about 15% by weight of rubber, and about 0.5% to about 10% by weight of plastic to form a dry component mixture;
heating about 3% to about 15% by weight of a wax until the wax has liquefied;
admixing the liquid wax into the dry component mixture to form a wax coated particulate composition, the percent by weight of each ingredient being based on the total weight of the composition;
cooling the particulate composition; and
depositing the cooled composition over an underlayer which is capable of drawing water away from an area.

18. The method of claim 17, further comprising the step of placing a separator layer between the composition and the underlayer.

19. The method of claim 17, further comprising the step of pre-heating the sand before mixing it with the other ingredients.

20. A sport or recreational surface prepared according to the method of claim 17.

21. A particulate composition for use as a sport or recreational surface comprising:
(A) of about 50% to about 92% by weight of sand;
(B) about 3% to about 15% by weight of wax;
(C) about 0.5% to about 10% by weight of cut length elastic fibers (CLEFs);
(D) about 0.5% to about 10% by weight of polyester fibers;
(E) one or more materials selected from the group consisting of (i) about 0.5% to about 10% by weight of a natural and/or synthetic fiber, (ii) about 0.5% to about 10% by weight of plastic, (iii) about 1% to about 15% by weight of a tire fiber and/or tire cord; and (iv) a mixture of the components (i) and (ii), (ii) and (iii), (i) and (iii), or (i), (ii) and (iii), the percent by weight of each ingredient being based upon the total weight of the composition.

22. The particulate composition of claim 21, wherein said sand is about 85% by weight.

23. The particulate composition of claim 21, wherein said wax is about 7% by weight.

24. The particulate composition of claim 21, wherein said CLEF is about 1% by weight.

25. The particulate composition of claim 24, wherein said CLEF is at least one of spandex and lastol.

26. The particulate composition of claim 21, wherein said tire fibers and/or tire cord comprises at least one of recycled tires, recycled cable, industrial ground rubber, and recycled rubber floor mats.

27. The particulate composition of claim 21, wherein said tire fibers and/or tire cord comprise a mixture of industrial ground rubber and material recycled tires.

28. The particulate composition of claim 21, wherein said tire fiber and/or tire cord comprises at least one rubber material selected from the group consisting of a natural rubber, a synthetic “natural” rubber, an SBR, a neoprene rubber, a nitrile rubber, a butyl rubber, a hypalon rubber, an EP rubber, an urethane rubber, an epichlorohydrin rubber, a chlorinated polyethylene rubber, a polyvinyl chloride rubber, a polysulfide rubber, a silicon rubber, an acrylic rubber, a fluoroelastomer, a polyacrylic rubber, an EPM rubber, a tire fiber, a tire cord, and any combination thereof.

29. The particulate composition of claim 21, wherein said tire fibers and/or tire cord comprises rubber attached to pieces of fabric.

30. The particulate composition of claim 29, wherein said fabric is one or more fabrics selected from the group consisting of polyester, rayon, nylon, and olefin.

31. The particulate composition of claim 21, wherein said tire fiber and/or tire cord is not attached to fabric.

32. The particulate composition of claim 21, wherein said tire fibers and/or cord comprise at least one of material from recycled tires and industrial ground rubber.

33. The particulate composition of claim 21, wherein said fiber is a manufactured fiber.

34. The particulate composition of claim 21, wherein said synthetic fiber comprises at least one fiber selected from the group consisting of rayon, acetate, nylon, modacrylic, olefin, acrylic, polyester, PLA, vinyon, saran, spandex, vinalon, aramid, nomex, kevlar, modal, sulfar, lyocell, zylon, dyneema/spectra, rubber, and acrylontrile rubber.

35. The particulate composition of claim 21, wherein the plastic is selected from the group consisting of a low carbon chain polyolefin, a high density polyethylene, a low density polyethylene, a polypropylene, a cellulose-based plastic, a polystyrene, a polyvinyl chloride (PVC), a nylon particle, a polyurethane, a polyethylene terephthlate (PET), a polytetrafluoroethylene (PTFE), a polyamide, a polyester, a polycarbonate, an acrylonitrile butadiene styrene, a polyvinylidene chloride, a polytetrafluoroethylene, a plastarch material, a bakelite, a polylactic acid, an acrylic, and a combination thereof.

36. A particulate composition comprising:
sand in the range of about 50% to about 92% by weight;
wax in the range of about 3% to about 15% by weight;
cut length elastic fibers (CLEFs) in the range of about 0.5% to about 10% by weight;
polyester fibers in the range of about 0.5% to about 10% by weight; and
wherein each component is based on the total weight of the composition.

37. The particulate composition of claim 36, further comprising:
in the range of about 1% to about 15% by weight of rubber based upon total weight of the composition.

38. The particulate composition of claim 37, further comprising:
in the range of about 0.5% to about 10% by weight plastic based upon total weight of the composition.

39. The particulate composition of claim 38, further comprising:
in the range of about 0.5% to about 10% by weight of natural and/or synthetic fibers based upon total weight of the composition.

40. The particulate composition of claim 36, wherein said sand is about 85% by weight.

41. The particulate composition of claim 36, wherein said wax is about 7% by weight.

42. The particulate composition of claim 36, wherein said CLEFs is about 1% by weight.

43. The particulate composition of claim 36, wherein said CLEFs are selected from the group consisting of spandex, lastol, and a combination thereof.

44. The particulate composition of claim 37, wherein said synthetic fibers are selected from the group consisting of rayon, acetate, nylon, modacrylic, olefin, acrylic, polyester, PLA, vinyon, saran, spandex, vinalon, aramid, nomex, Kevlar, modal, sulfar, lyocell, zylon, dyneema/spectra, rubber, acrylontrile rubber, and any combination thereof.

45. The particulate composition of claim 44, wherein said manufactured fibers have a length in the range of about ½ inch to about 1¼ inches and have a thickness in the range of about 1/16 inch to about ⅛ inches.

46. The particulate composition of claim 37, wherein said rubber has a length in the range of about ¾ inch to about 1½ inches and a width in the range of about 1/16 inch to about ⅛ inch.

47. The particulate composition of claim 46, wherein the rubber comprises at least one material selected from the group consisting of a natural rubber, a synthetic “natural” rubber, an SBR, a neoprene rubber, a nitrile rubber, a butyl rubber, a hypalon rubber, an EP rubber, an urethane rubber, an epichlorohydrin rubber, a chlorinated polyethylene rubber, a polyvinyl chloride rubber, a polysulfide rubber, a silicon rubber, an acrylic rubber, a fluoroelastomer, a polyacrylic rubber, an EPM rubber, a tire fiber, a tire cord, and any combination thereof.

48. The particulate composition of claim 38, wherein said plastic has a length of about ¾ inch long and a thickness of about 1/24 inch.

49. The particulate composition of claim 48, wherein the plastic particle is selected from the group consisting of a low carbon chain polyolefin, a high density polyethylene, a low density polyethylene, a polypropylene, a cellulose-based plastic, a polystyrene, a polyvinyl chloride (PVC), a nylon, a polyurethane, a polyethylene terephthlate (PET), a polytetrafluoroethylene (PTFE), a polyamide, a polyester, a polycarbonate, an acrylonitrile butadiene styrene, a polyvinylidene chloride, a polytetrafluoroethylene, a plastarch material, a bakelite particle, a polylactic acid, an acrylic, and any combination thereof.

50. The particulate composition of claim 36, wherein said surface composition is spread over an underlayer capable of drawing water away from said surface composition.

51. The particulate composition of claim 50, wherein a water-permeable separator layer is placed between said surface composition and the underlayer.

52. The particulate composition of claim 50, wherein the underlayer comprises an aggregate layer.

53. The particulate composition of claim 52, wherein the aggregate layer is one or more compounds selected from the group consisting of crushed stone, broken stone, gravel, stone, quarry, granite, limestone, and dust.
